(19) United States
(12) Patent Application Publication
(10) Pub. No.: US 2006/0236568 A1
(43) Pub. Date: Oct. 26, 2006

(54) Greeting card-gift card-postage stamp assembly

(76) Inventors: Barry R. Switzer, Clarence, NY (US); Joseph M. Sheeran, East Amherst, NY (US); Kelly M. Smith, Alexandria, VA (US)

Correspondence Address: JAECKLE FLEISCHMANN & MUGEL, LLP, 190 Linden Oaks, ROCHESTER, NY, 14625-2812, US

(21) Appl. No.: 11/114,710

(22) Filed: Apr. 26, 2005

(51) Int. Cl. G09F 1/00

(52) U.S. Cl. 40/124.11

(57) ABSTRACT

A greeting card assembly includes two panels that define a front cover and a back cover and are attached to one another along a fold line. One or more individually detachable self adhesive postage stamps form a portion of at least one face of one of the panels, and a gift card containing scanable data is detachably affixed to one of the panels. The gift card can be a prepaid telephone calling card.

### FIELD OF THE INVENTION

The present invention relates generally to greeting cards and, more particularly, to greeting card assemblies that include postage stamps and gift cards such as, for example, telephone calling cards.

### BACKGROUND OF THE INVENTION

Greeting cards constitute a frequently used means of communication between individuals, often being employed by the sender of the card to convey to the recipient a personal message on the occasion of a birthday, graduation, wedding, or other celebratory event. In addition, a sender may send a greeting card containing a friendly sentiment to a recipient simply as a means of fostering or maintaining ongoing communication.

Commercial greeting cards suitable for almost every imaginable occasion are widely available. Typically they include attractive artwork and preprinted greetings and sentiments, often in verse form, along with sufficient blank space to allow for addition of a handwritten message and signature. A greeting card, sometimes accompanied by a gift, may be presented personally by the sender to the recipient, but frequently the sender, either by choice or out of necessity, mails the card to the recipient.

The telephone is an essential communication tool in the activities of everyday life, but it is also frequently used to convey greetings and congratulatory messages on occasions for celebration. A long-distance call on such an occasion from a well-wisher living far away is especially valued, at least in part because of the recognition of the additional cost incurred by the caller to converse with the recipient. In many instances, the cost of the long-distance call may be charged to a home telephone account; where this is not possible or convenient, the call may be paid for using a telephone card validated for a specified amount of prepaid usage.

The complementing communication value of telephone calling with mailed greeting cards has been recognized in the prior art. For example, Fonseca, U.S. Pat. No. 5,629,977, the disclosure of which is incorporated herein by reference, describes a greeting card provided with an envelope that contains an inside compartment adapted to hold a telephone calling card. Also, Waldron, U.S. Pat. No. 6,698,116, the disclosure of which is incorporated herein by reference, describes a greeting card that encloses a telephone card connected to the greeting card by a hinge, the telephone card being concealed while the greeting card is closed but pivoting into view when the greeting card is opened.

Orr et al., U.S. Pat. Nos. 5,984,091 and 6,002,766, the disclosures of which are incorporated herein by reference, describe a compartmented package having a first compartment that contains a souvenir postcard with a pictorial representation and a second compartment that contains a utilitarian item, which can be a telephone card, with a matching pictorial representation.

Clark, U.S. patent application Ser. No. 2004/0093773, the disclosure of which is incorporated herein by reference, describes a message card that includes a holder for securing a transaction card, the transaction card being in a concealed first position within the holder when the message card is in a closed state and moving into a viewable second position when the message card is in an open state.

Kim, U.S. Pat. No. 6,269,158, the disclosure of which is incorporated herein by reference, describes a card unit system that includes a detachable telephone calling card attached to a postcard whose first side displays materials such as images, photographs, gift certificates and coupons, and whose second side includes a postage square, address section, addressee section and toll-free number.

Carless et al., U.S. Pat. No. 5,873,603, the disclosure of which is incorporated herein by reference, describes a greeting card/postcard device containing three foldable panels hinged to form a stacked array, the third panel being intermediate between and detachable from the first and second panels; adhesive means on at least one of the second and third panels for attaching a photograph to the panel; and means for covering the adhesive means prior to attaching the photograph.

### SUMMARY OF THE INVENTION

The present invention is directed to a greeting card assembly that comprises a first panel that has an outer face and an inner face and defines a front cover for the greeting card assembly, and a second panel that has an outer face and an inner face and defines a back cover for the greeting card assembly, the second panel being attached to the first panel along a fold line. A gift card comprising scanable data, preferably from magnetic stripe, bar code or chip technology, is detachably affixed to one of the faces of the first and second panels, and one or more postage stamps that are individually detachable from the greeting card assembly comprise a portion of at least one of the inner faces of the first and second panels.

At least one of the first and second panels comprises a laminate of a paper sheet having a pressure-sensitive adhesive surface and a release liner sheet in releasable contact with the adhesive surface. The paper sheet comprises one or more die-cut postage stamps that have a pressure-sensitive adhesive surface and are individually releasable from the release liner sheet.

### Brief Description of the Drawings

FIG. 1 is a perspective view of the greeting card assembly that depicts the inner faces of the first and second panels.

FIG. 2 is a perspective view of the greeting card assembly that shows the outer face of the first panel.

FIG. 3 is a perspective view of another embodiment of the greeting card assembly that depicts the inner faces of the first and second panels.

FIG. 4 is an upper elevational view, not to scale, of a preferred embodiment of the greeting card assembly that illustrates the laminate structure of the first and second panels.

### Detailed Description of the Invention

In accordance with the present invention, at least one of the first and second panels of the greeting card assembly comprises a laminate of a paper sheet having a pressure-sensitive adhesive surface and a release liner sheet in releasable contact with the adhesive surface. In a preferred embodiment, both panels are formed from the paper sheet-adhesive-release liner sheet laminate, and the release liner sheet comprises the outer faces of both panels. Preferably, the paper comprising both panels is suitable for postage stamp manufacturing.

Also in a preferred embodiment of the invention, the gift card comprising scanable data is detachably affixed to an inner face of either the first or second panel of the greeting card assembly. Also preferably, the one or more stamps included in the paper sheet of the assembly comprise a plurality of contiguously positioned self-adhesive postage stamps, which are individually removable from the release liner sheet.

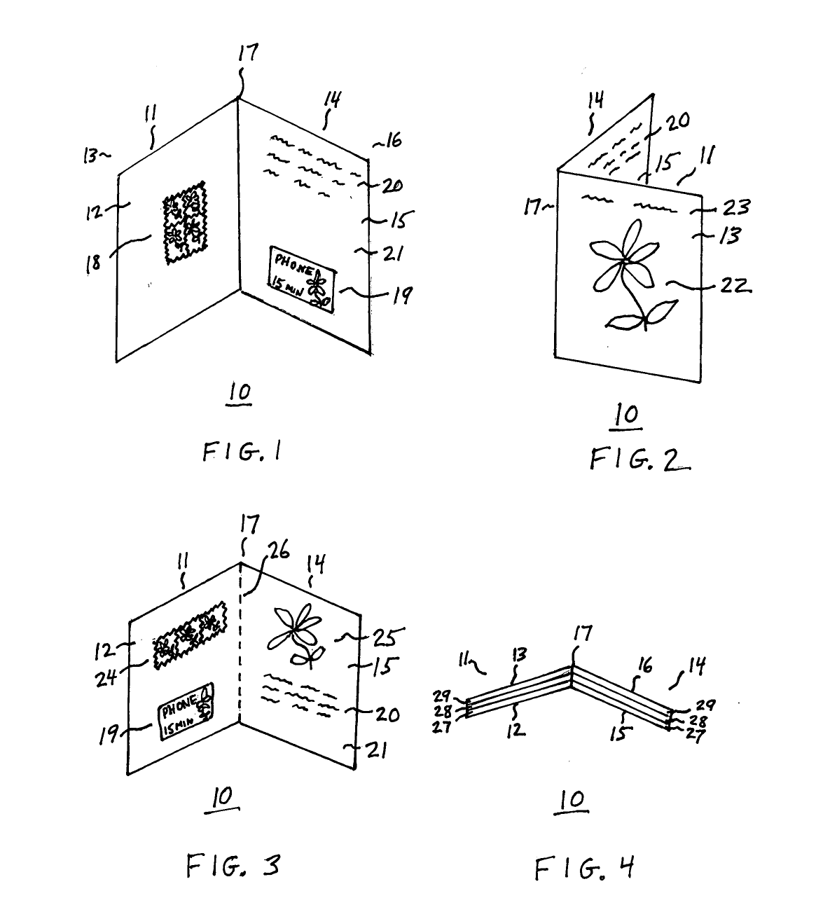

FIG. 1 depicts a greeting card assembly 10 that includes a first panel 11 having an inner face 12 and an outer face 13 (not visible) and a second panel 14 having an inner face 15 and an outer face 16 (not visible). First panel 11 is connected to second panel 14 along a fold line 17. Inner face 12 of first panel 11 includes a plurality of postage stamps 18, depicted as a pane of four stamps that are individually detachable from first panel 11. A prepaid telephone card 19 is detachably affixed to inner face 15 of second panel 14. Inner face 15 also includes a preprinted greeting or message 20 and a blank space 21 for adding a handwritten message and signature.

FIG. 2 includes the outer face 13 of first panel 11. Outer face 13 includes decorative artwork 22 and a preprinted greeting or message 23.

FIG. 3 depicts another embodiment of greeting card assembly 10 in which inner face 12 of first panel 11 includes a plurality of postage stamps 24, depicted as a strip of three stamps that are individually detachable from first panel 11. In this embodiment, prepaid telephone card 19 is detachably affixed to inner face 12 of first panel 11. Inner face 15 of second panel 14 includes decorative artwork 25, along with preprinted greeting or message 20 and blank space 21 for adding a handwritten message and signature. Fold line 17 includes perforations 26, enabling separation of first panel 11 from second panel 14.

FIG. 4 depicts the laminate structure of first panel 11 and second panel 14 of a preferred embodiment of greeting card assembly 10. Inner face 12 of first panel 11 and inner face 15 of second panel 14 preferably comprise a continuous paper sheet 27 having a pressure-sensitive adhesive surface 28, to which is releasably adhered a release liner sheet 29.

The laminate structure depicted in FIG. 4 enables die-cut self-adhesive postage stamps to be printed on the paper sheet 27 comprising inner face 12 of first panel 11 and/or inner face 15 of second panel 14, from which they can be individually released from release liner sheet 29. However, if it were desired to print the postage stamps on outer face 13 of first panel 11 as an element of the card design, the layer arrangement of the laminate would be reversed, i.e., release liner sheet 29 would provide inner faces 12 and 15 of, respectively, panels 11 and 14.

The greeting card-gift card-postage stamp assembly of the present invention provides a beneficial incentive to promote communication between the sender of the assembly and the recipient. The enclosed self-adhesive postage stamps, which are individually releasable from the greeting card, would encourage a prompt mailed thank-you response from the recipient. The gift card comprises scanable data and can be, for example, a gift certificate card for the purchase of prepaid goods or services, a prepaid internet card, or a prepaid telephone calling card. In the instance where the gift card is a prepaid telephone card, the recipient is provided with a further means of ready communication with the sender.

The telephone card, which allows a predetermined number of telephone call minutes, is releasably attached to one of the inner faces of the card, preferably with a small amount of a commercial adhesive intended to provide easy separation of two temporarily connected items. Preferably the telephone card is formed from plastic suitable for mechanical electronic reading and is of a size that enables it to be readily carried in a wallet or purse.

The postage stamps included in the greeting card assembly bear selected official government postage stamp images. If desired, the printed decorative artwork on the card and on the telephone call gift card can be coordinated with the postage stamp image. An envelope provided for mailing the greeting card assembly can also be decorated with similarly coordinated artwork.

The optional perforation along the fold line connecting the panels of the greeting card serves to facilitate the folding of the laminate structure used to form the panels. In addition, it enables the separation of the panels, making it convenient to place a decorative panel of the card in a picture frame or a scrapbook. Also, if desired, the separated second panel can be used as a reply card, the rear face of the panel providing space for an address and for a postage stamp, which can be pre-attached.

The invention has been described in detail with particular reference to certain preferred embodiments thereof, but it is understood that variations and modifications can be effected within the spirit and scope of the invention, which is defined by the claims that follow.

What is claimed is:

1. A greeting card assembly comprising:
a first panel having an outer face and an inner face, said first panel defining a front cover for said greeting card assembly;
a second panel having an outer face and an inner face, said second panel being hingedly attached to said first panel along a fold line and defining a back cover for said greeting card assembly;
a gift card comprising scanable data detachably affixed to one of said faces of said first and second panels; and
one or more postage stamps comprising a portion of at least one of said faces of said first and second panels, said one or more postage stamps being individually detachable from said greeting card assembly;
wherein at least one of said first and second panels comprises a laminate of a paper sheet having a pressure-sensitive adhesive surface and a release liner sheet in releasable contact with said adhesive surface of said paper sheet; and
wherein said paper sheet comprises one or more die-cut postage stamps having a pressure-sensitive adhesive surface, said postage stamps being individually releasable from said release liner sheet.

2. The greeting card assembly of claim 1 wherein both said first and second panels comprise said laminate of said paper sheet and said release liner sheet.

3. The greeting card assembly of claim 1 wherein said paper sheet comprises said inner faces of said first and second panels, and said release liner sheet comprises said outer faces of said first and second panels.

4. The greeting card assembly of claim 1 wherein said gift card comprising scanable data is detachably affixed to an inner face of said first panel or said second panel.

5. The greeting card assembly of claim 1 wherein said gift card comprising scanable data is selected from the group consisting of a gift certificate card for the purchase of prepaid goods or services, a prepaid internet card, and a prepaid telephone calling card.

6. The greeting card assembly of claim 5 wherein said gift card is a prepaid telephone calling card.

7. The greeting card assembly of claim 1 wherein said gift card is a rectangular plastic card, said plastic card being detachably affixed to one of said faces of said first and second panels by an adhesive.

8. The greeting card assembly of claim 1 wherein said one or more postage stamps comprises a plurality of contiguously positioned postage stamps.

9. The greeting card assembly of claim 8 wherein said one or more postage stamps comprises a rectangular pane containing four postage stamps.

10. The greeting card assembly of claim 1 wherein said gift card is detachably affixed to said inner face of said second panel, and said paper sheet comprising said one or more postage stamps comprises the inner face of said first panel.

11. The greeting card assembly of claim 1 wherein said gift card is detachably affixed to said paper sheet comprising said one or more postage stamps.

12. The greeting card assembly of claim 1 wherein at least one of said outer and inner faces of said first and second panels comprises artwork.

13. The greeting card assembly of claim 1 wherein at least one of said outer and inner faces of said first and second panels comprises a preprinted greeting or message.

14. The greeting card assembly of claim 1 wherein at least one of said outer and inner faces of said first and second panels comprises space for adding a handwritten message and signature.

15. The greeting card assembly of claim 1 wherein said fold line is perforated, thereby enabling separation of said first panel from said second panel.
